(19) United States
(12) Patent Application Publication
(10) Pub. No.: US 2025/0076539 A1
(43) Pub. Date: Mar. 6, 2025

(54) METASURFACE HOLOGRAPHIC OPTICAL TRAPS FOR ULTRACOLD ATOMS

(71) Applicant: The Trustees of Columbia University in the City of New York, New York, NY (US)

(72) Inventors: Nanfang Yu, Fort Lee, NJ (US); Sebastian Will, New York, NY (US)

(73) Assignee: The Trustees of Columbia University in the City of New York, New York, NY (US)

(21) Appl. No.: 18/823,256

(22) Filed: Sep. 3, 2024

Related U.S. Application Data
(60) Provisional application No. 63/535,691, filed on Aug. 31, 2023.

(51) Int. Cl. G02B 1/00; G21K 1/00

(52) U.S. Cl. CPC G02B 1/002; G21K 1/006; G02B 2207/101

(57) ABSTRACT

The subject matter discloses a metasurface hologram system, including at least a vacuum chamber, where an atomic array is configured to be trapped with various geometries, at least a laser generator, configured to generate one or more incident laser beams, and at least a metasurface hologram, configured to generate trap arrays.

### CROSS-REFERENCE

This U.S. non-provisional application claims priority of U.S. provisional application, Ser. No. 63/535,691, which was filed on Aug. 31, 2023, the entire disclosures of which are incorporated herein by reference.

### STATEMENT REGARDING FEDERALLY SPONSORED RESEARCH

This invention is made with government support under the National Science Foundation (grant no. 1936359 and no. 2004685). The government has certain rights in the invention.

### BACKGROUND

The exploration of optical traps has contributed to various fields of science and technology, ranging from fundamental physics to practical applications in quantum computing and quantum simulation. Optical traps, also known as optical tweezers, can be tools for manipulating and controlling microscopic particles, such as atoms and molecules, with precision and versatility.

Certain optical traps have been generated using bulk optical components, such as lenses and mirrors, which can suffer from limitations in scalability, efficiency, and thermal stability.

There is a need for optical trap arrays with improved geometric configurations, high optical efficiency, positioning accuracy, and intensity uniformity of trap arrays.

### SUMMARY

The disclosed subject matter provides metasurface systems for generating optical traps. Such systems can generate optical trap arrays with various geometric configurations for applications including atomic clocks.

A exempalary metasurface holographic system includes a vacuum chamber, where an atomic array is configured to be trapped with various geometries, at least a laser generator, configured to generate one or more incident laser beams; and at least a metasurface hologram, configured to generate trap arrays.

In certain embodiments, the metasurface hologram is positioned outside the vacuum chamber.

In certain embodiments, the metasurface hologram system includes at least an optical component, which can be a lens, positioned between the metasurface hologram and vacuum chamber.

In certain embodiments, the metasurface hologram includes meta-units composed of polarization-independent and/or polarization-multiplexed units. The meta-units can include TiO₂ nanopillars.

In certain embodiments, the trapped atomic array includes at least 3×3 square lattice array. The trapped atomic array includes periodic and/or aperiodic geometry configurations with dimensions from 1D to 3D. The trapped atomic array includes one or more geometries of quasi-crystals, kagome lattices, and twisted bilayers. Additionally, the trapped atomic array is configured to split into two parts, which are then realized by the two orthogonal polarization states.

In certain embodiments, the vacuum chamber is loaded with atomic gas. The atomic array can include one or more atoms of alkali atoms, strontium, and ytterbium.

In certain embodiments, a variation of spot sizes for the trapped atomic array ranges from 3% to 5%. A variation of an intensity uniformity of the trapped atomic arrays ranges from 12% to 16%. A spacing between the trapped atomic array is equal to or less than 1.25 μm. A thermal stability of the trapped atomic arrays include a drift less than 0.5 μm along a vertical direction thereof, and a drift equal to or less than 2.5 μm along a horizontal direction thereof.

### BRIEF DESCRIPTION OF THE DRAWINGS

It is to be understood that both the foregoing general description and the following detailed description are exemplary and are intended to provide further explanation of the disclosed subject matter. The patent or application file contains at least one drawing executed in color. Copies of this patent or patent application publication with color drawing(s) will be provided by the Office upon request and payment of the necessary fee.

FIG. 1a provides a schematic illustration of an example metasurface hologram system to generate optical trap arrays for cold atoms. FIGS. 1b-1d illustrate three example configurations where a metasurface hologram is used to generate trap arrays for cold atom use cases.

FIG. 2a provides a schematic illustration of example polarization-independent meta-units and calculated phase responses of a library thereof. FIG. 2b provides a schematic illustration of example birefringent meta-units with asymmetric cross-sectional shapes and the calculated phase responses of a library thereof. FIG. 2c provides a dark-field microscope image of an example fabricated metasurface hologram for generating the 1D dimerized trap array. FIG. 2d provides a schematic illustration of calculated phase response for generating the ring array with a specific spacing between adjacent spots. FIG. 2e provides SEM images of a fabricated polarization-independent metasurface in a top view (left) and in a perspective view (right), respectively. FIG. 2f provides SEM images of a fabricated birefringent metasurface in a top view (left) and in a perspective view (right), respectively. FIG. 2g provides a compared curve of simulated peak intensities of a ring array with 1.5 μm spacing using the checkerboard method (blue) and the conventional approach (red). FIG. 2h provides a schematic illustration of an example setup used for optical characterization of trap arrays.

FIGS. 3a-3c provide a schematic illustration of geometry configurations and measured intensity profiles of an example 1D dimerized trap array with 5 μm spacing between dimers (FIG. 3a), a small ring array with 1.5 μm spacing (FIG. 3b), and a larger ring array with 1.25 μm spacing (FIG. 3c).

FIGS. 4a-4d provide a schematic illustration of geometry configurations and measured intensity profiles of an example 2D square lattice with a lattice constant of 1.8 μm (FIG. 4a), a kagome lattice with minimum spacing between adjacent spots of 5 μm (FIG. 4b), a Penrose-tiling type quasi-crystal lattice with minimum spacing between adjacent spots of 7.5 μm (FIG. 4c), and a Penrose-tiling type quasi-crystal lattice with reservoir traps and minimum spacing between adjacent spots of 4.5 μm (FIG. 4d).

FIGS. 5a-5d provide a schematic illustration of geometry configurations and measured intensity profiles of a twisted bilayer consisting of two honeycomb lattices separated (FIG. 5a), overlayed twisted honeycomb lattices (FIG. 5b), overlayed twisted triangular lattices (FIG. 5c), and a 3D cubic lattice (FIG. 5d).

FIG. 6a provides a schematic illustration of geometry configurations and measured intensity profiles of a polarization-switchable ring array in an intact state (top) and a defective state (bottom). FIG. 6b provides a schematic illustration of geometry configurations and measured of a ring array as a function of the rotation angle of a half-wave plate. FIG. 6c provides a schematic illustration of geometry configures and measured intensity profiles of a polarization-multiplexed square lattice.

FIG. 7 provides a schematic illustration of geometry configurations and measured thermal drifts of a polarization-switchable ring array,

FIGS. 8a-8f provide a schematic illustration of statistical histograms of measured geometrical parameters and intensities of optical traps generated by metasurfaces. FIGS. 8a-8b illustrate the distributions of the width and height of individual traps, respectively, of the 14×14 square lattice. FIGS. 8c-8d illustrate the distributions of the lattice constant of the 14×14 square lattice along the horizontal and vertical directions, respectively. FIGS. 8e-8f illustrate the distributions of the peak intensity and integrated power of the quasi-crystal trap, respectively.

### DETAILED DESCRIPTION

Disclosed herein are emobidments of metasurface hologram systems to generate densely spaced optical traps with designer configurations from 1D to 3D with high quality and efficiency. Additionally, the performance evaluation of the disclosed metasurface holograms is characterized by the features of trap arrays.

### Metasurface

Metasurface or “metasurface hologram”, used herein, refers to a platform to shape and manipulate optical waves. Typically, a metasurface hologram is composed of 2D arrays of optical scatterers (dubbed “meta-units”), the sizes and shapes of which can be tailored to control amplitude, phase, and polarization over the optical wavefront. In certain embodiments, metasurfaces have a planar form factor, as the height of meta-units, typically ranging from a few hundred nanometers to one micron, is small compared to the transverse dimension of a metasurface, ranging from tens of microns to several centimeters. The subwavelength periodicity of meta-units allows for high forward-scattering efficiency and molding of the optical wavefront with high spatial resolution.

The controllable design of an optical phase by a metasurface hologram can be realized through a dispersion engineering or polarization conversion. In certain embodiments, the meta-units of the metasurface hologram are treated as short waveguide segments standing on a substrate. They can possess various cross-sectional shapes, and thus support waveguide modes with different modal indices, depending on the spatial overlap between the mode and the dielectric material. Thereby, via the modulation of designed meta-units, the different optical phase and geometry can be achieved. In certain embodiments, optical components can be further integrated with the metasurface to generate adjusted focal spots and phase plates that could generate various geometries desired.

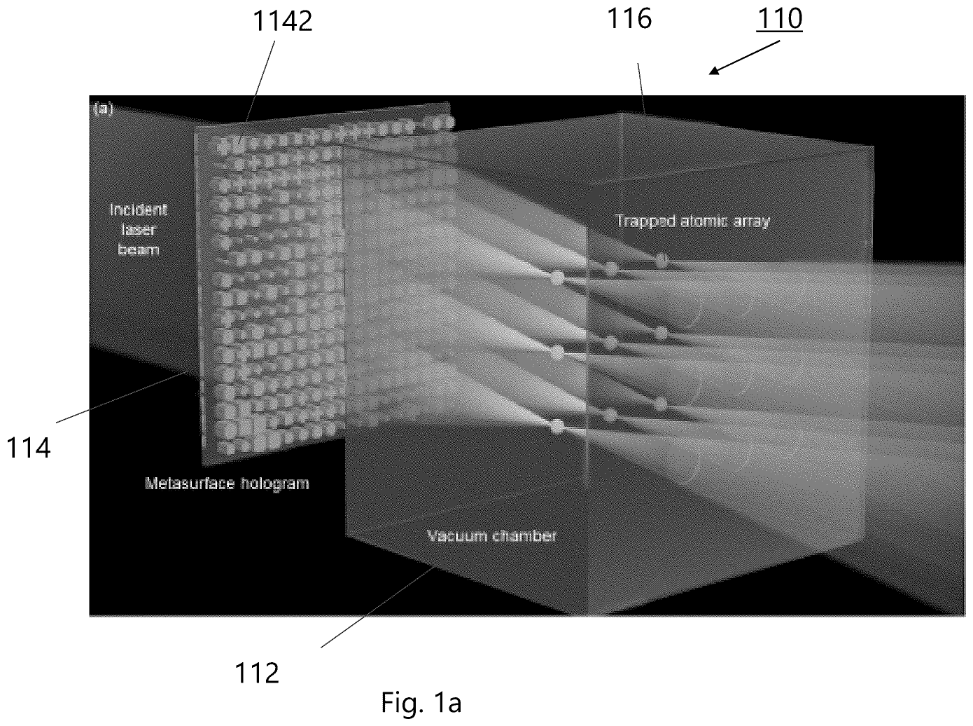

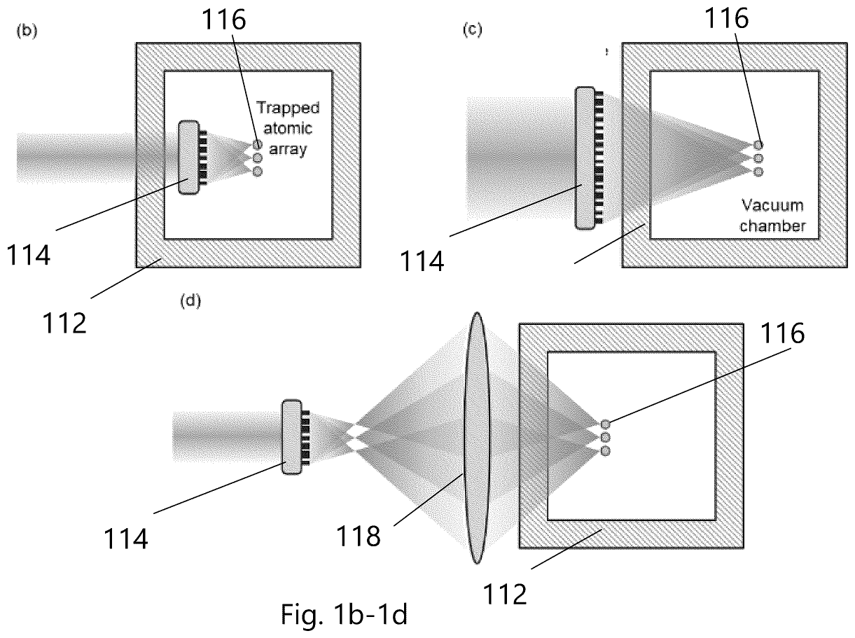

FIG. 1a shows a schematic illustration of an example metasurface hologram system to generate optical trap arrays for cold atoms (e.g., atoms that have been cooled to low temperatures via various cooling techniques, and their quantum properties become important). In the metasurface hologram system 110, the metasurface hologram 114 modulates the incident laser beam (the laser system is shown) without the assistance of any other optical components and forms an optical trap array 116 in a vacuum chamber 112. Herein, a 3×3 square lattice array is loaded within the trap arrays as an example, but the geometry of the trap arrays can be arbitrary. The composed meta-units for the metasurface hologram 114 include a plurality of 2D arrays of meta-units 1142, functionalized as optical scatterers for directing or adjusting the incident laser.

Certain alternative arrangements for metasurface hologram system setups in accordance with the disclosed subject matter are illustrated in FIGS. 1b-1d. FIG. 1b illustrates a fully integrated metasurface hologram in a vacuum chamber, where a metasurface hologram 114 is placed directly inside a vacuum chamber 112 with the atomic gas, and the optical trap array 116 does not require extra free-space optical components. The metasurface hologram 114 has a moderate size (e.g., a few hundred microns to 1 mm in linear dimension), and a short focal distance (e.g., tens to a few hundred microns). The numerical aperture (NA) of the metasurface hologram 114 does not have a strict limitation and can be above 0.9 to generate tightly focused and densely packed trap spots, where the trap spots are highly concentrated at the focal plane within the generated array.

FIG. 1c illustrates a large metasurface hologram outside the vacuum chamber, wherein a metasurface hologram 114 is placed outside the vacuum chamber 112 and the optical trap array 116 is formed inside the vacuum chamber 112, with no relay optics component. The metasurface hologram 114 can be larger (e.g., from one to a few centimeters in linear dimension) and have a longer focal length (e.g., on the order of 1 cm) compared to the metasurface hologram setup in FIG. 1a to be account for light propagation inside the window of the vacuum chamber. In this embodiment, the NA of the metasurface can still be large (e.g., larger than 0.5). The metasurface hologram 114 design should account for light propagation through the vacuum chamber 112 window (i.e., angle-dependent phase delay and transmittance of light propagation through the window). The fabrication routine can be altered to accommodate the increased metasurface sizes.

FIG. 1d illustrates a metasurface hologram outside the vacuum chamber with an optics component, where a metasurface hologram 114 is placed outside the vacuum chamber 112, and an optics component 118, e.g., a lens, is used to modulate the generated holographic trap array 116 into the vacuum chamber 112. In this embodiment, integration into an existing optical setup is most readily achievable. Accordingly, in a following setup, the objective used as the optic component 118 can compensate for light propagation through a thick quartz wall of the vacuum chamber 112.

### Design and Fabrication of Metasurface Holograms

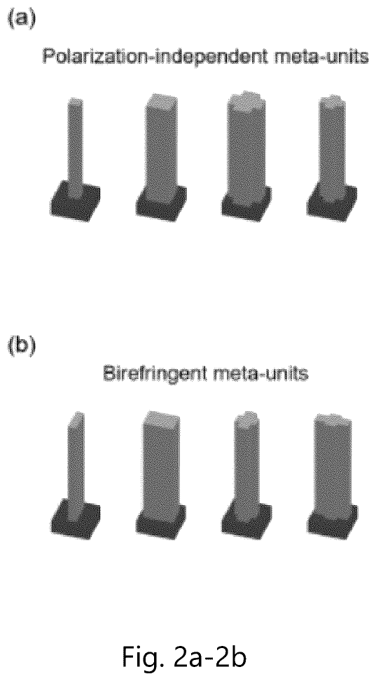

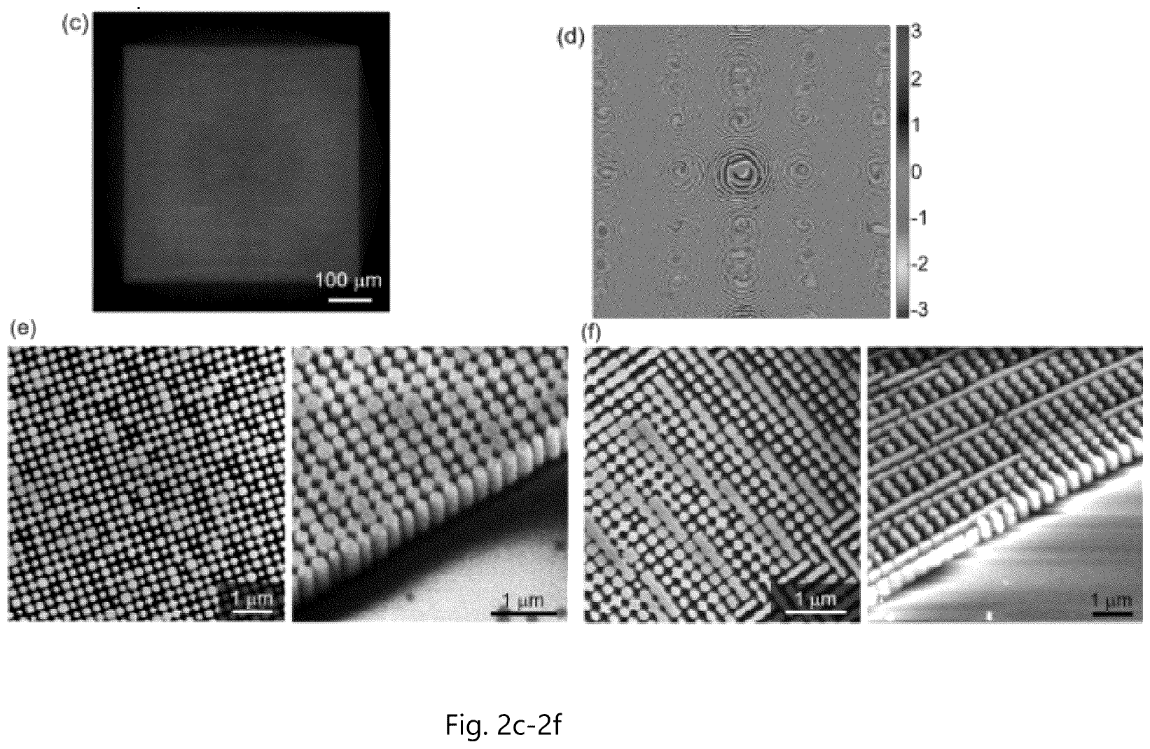

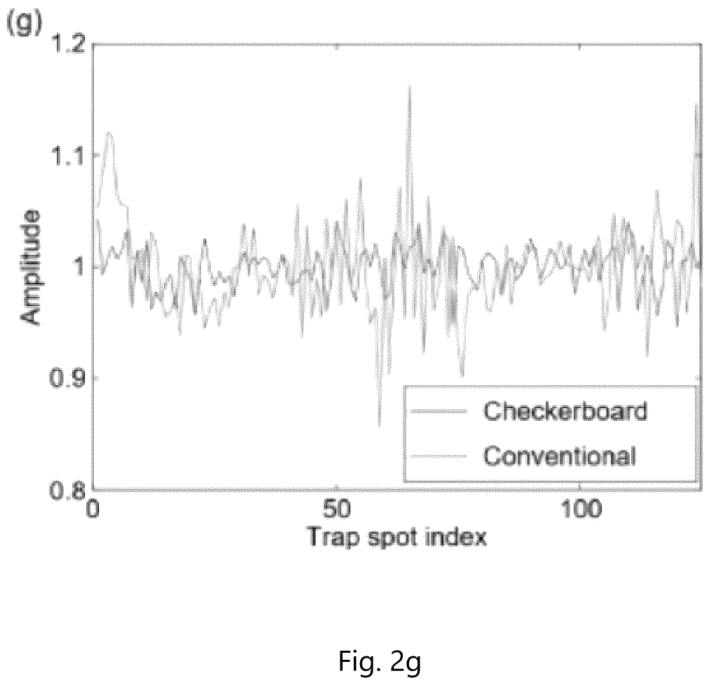

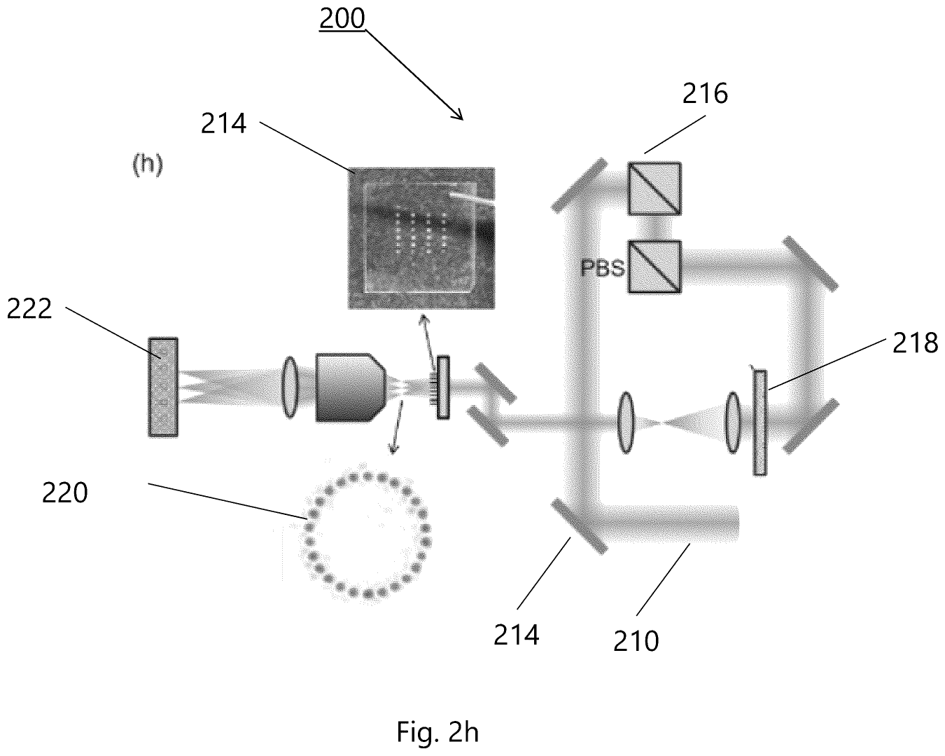

In certain embodiments, the subject matter designs and realizes both polarization-independent and polarization-multiplexed meta-units for the metasurface hologram using TiO₂ nanopillars patterned on an optically thick fused silica substrate to operate at a specific wavelength, e.g., λ=520 nm, with the magic wavelength for the 5s^{2 1}S₀ to 5s5p ³P₁|m_{J}=0 [symbol] transition of ⁸⁸Sr calculated for linearly polarized light at zero magnetic field. Through the above design, the amplitude and phase responses of individual TiO₂ meta-units are obtained using rigorous coupled-wave analysis (RCWA) calculations. The polarization-independent meta-units include nanopillars that have cross-sectional shapes with 4-fold symmetry (i.e., squares and crosses) and provide fixed phase responses irrespective of the polarization state of light; the polarization-multiplexed meta-units consist of birefringent nanopillars, providing independent control of optical phase at the two orthogonal polarization states. The calculated phase responses for the two meta-unit libraries are shown in FIG. 2a and FIG. 2b, respectively.

With reference to FIG. 2a, polarization-independent meta-units are presented, and the phase responses of a library of about 400 meta-units are calculated. The whole library can cover the 2π phase range multiple times. The meta-units have square and cross-shaped cross-sections, and are ordered and indexed by dimensions thereof. Alternatively, FIG. 2b illustrates birefringent meta-units with asymmetric cross-sectional shapes, and the phase responses of a library of about 3000 meta-units are calculated. The two axes denote phase responses at two orthogonal polarization states, respectively. The library provides a dense sampling over the entire 2D phase space, demonstrating complete and independent control of phase at the two polarization states simultaneously. Because of the low absorption of TiO₂ in the visible spectrum, both libraries have an average optical transmission of more than 90%.

A calculation method based on, e.g., Gerchberg-Saxton, can be used to calculate the phase masks required for producing the desired optical traps. In particular, the Rayleigh-Sommerfeld diffraction integral can be used to iteratively propagate back and forth between the metasurface plane and focal plane, while enforcing the phase-only condition upon the metasurface hologram. Thereby, such a calculation identifies the optimal phase profile that produces an intensity pattern on the focal plane that most closely matches the desired trap arrays, shown in FIG. 2d. Specifically, the target intensity of the (N+1)^{th} iteration, I_{N+1(x, y)}, is determined by the simulated intensity of the Nₜₕ iteration, I_{N(x, y)}, via

$${I}_{N + 1} ( x , y ) = \frac{{I}_{ideal} ( x , y )}{{I}_{N} ( x , y )} , \qquad ( 1 )$$

where I_{ideal(x, y)} is the ideal binary intensity distribution with unity amplitude at trap locations and zero elsewhere. In this manner, trap arrays brighter than intended (i.e., intensity larger than 1) are suppressed while traps darker than intended (i.e., intensity smaller than 1) are enhanced, resulting in a more uniform pattern. By sweeping over all the lattice positions on the metasurface and choosing meta-units to minimize phase error locally, the metasurface hologram can generate an optimal layout of meta-units with a collective phase profile that replicates the phase modulation prescribed by the algorithm. For polarization multiplexed traps, this process can be done in parallel for the two polarization states; that is, the choice of a meta-unit at a certain position of the metasurface in reference to the meta-unit bibrary (shown in FIG. 2b) can minimize the local phase errors at both polarization states.

In certain embodiments, a “checkerboard” technique is employed for the generation of some arrays with closely spaced traps (e.g., 1D ring arrays, 2D square lattices). In this technique, the entire array is split evenly into two parts in the spirit of a checkerboard dividing a square surface; the two parts are then realized by the two orthogonal polarization states. This technique allows to realize large arrays with tight spacings between traps, while maintaining high quality of individual traps.

In the embodiment shown in FIG. 2g, a ring array with 1.5 μm spacing is used via both the conventional method and the checkerboard technique to compare on the peak intensity variations of the simulated trap spots. The compared results show that the checkerboard technique significantly improved the quality of the array with a much weaker spot-to-spot intensity variation. An optical image and scanning electron micrograph (SEM) images of fabricated metasurface holograms are shown in FIGS. 2c, 2e, and 2f. FIG. 2e shows SEM images of a fabricated polarization-independent metasurface in a top view (left) and in a perspective view (right), respectively. FIG. 2f shows SEM images of a fabricated birefringent metasurface in a top view (left) and in a perspective view (right), respectively. The SEM images show that the nanopillars retain the designed cross-sectional geometries and have vertical sidewalls.

In certain embodiments, metasurface holograms designed using the above strategies can be fabricated using standard CMOS (complementary metal-oxide-semiconductor)-compatible nano-fabrication techniques. In particular, a thin film of TiO₂ of 800 nm in thickness can be deposited by electron beam evaporation of Ti₃O₅ in an oxygen-rich atmosphere on 500 μm thick fused quartz substrates. For example, electron beam lithography (Elionix ELS-G100) can be conducted on a bilayer resist (PMMA 495k A4 and 950k A2) spun on top of the film with a dose of 770 μC/cm2 at a current of 2 nA. A 20-nm layer of E-Spacer can be spun on top of the double-layer resist to avoid the electron charging effect. The exposed resist is subsequently developed in an IPA:DI (3:1) solution for 2 min and coated with a bilayer etch mask of a 25 nm Cr film and a 15 nm Al₂O₃ film using electron beam evaporation. The mask is then lifted off in Remover PG overnight and the metasurface pattern is etched into the TiO₂ film in an inductively coupled plasma etcher (Oxford PlasmaPro 100 Cobra). Finally, the mask is removed after immersion in Cr etchant 1020 for 2 min. The metasurface holograms have a linear dimension of ˜400-560 μm and a numerical aperture (NA) of ˜0.45, leading to a diffraction-limited trap spot size of ˜500 nm at λ=520 nm.

An exemplary schematic of the measurement setup 200 is shown in FIG. 2h. The output from a laser 210 with a range of wavelength, e.g., k=520 nm (Azurlight ALS-GR-520-5-A-CP-SF) is first treated with polarization optics, e.g., reflecting plates 212, polarizing beam splitters (PBS) 216, half-wave plate 218, and some lens, and then modulated by a metasurface hologram 214. The generated optical trap array 220 can be imaged by a charged-coupled device (CCD) camera 222 equipped with an NA=0.6 objective. The effective magnification of the imaging system can be calibrated by using the 1951 US Air Force resolution test chart, so that the geometry and spacing of generated trap spots can be accurately measured.

### Performance Evaluation

Herein, a trap array quality of the metasurface hologram system disclosed is quantified by the positioning accuracy, and size and intensity uniformity of individual generated traps, and the efficiency is characterized by the fraction of power focused onto the trap sites versus that of the incident light. Thereby, the performance of the disclosed metasurface can be aligned with such a characterization for a trap array quality, including positioning accuracy, size, and intensity.

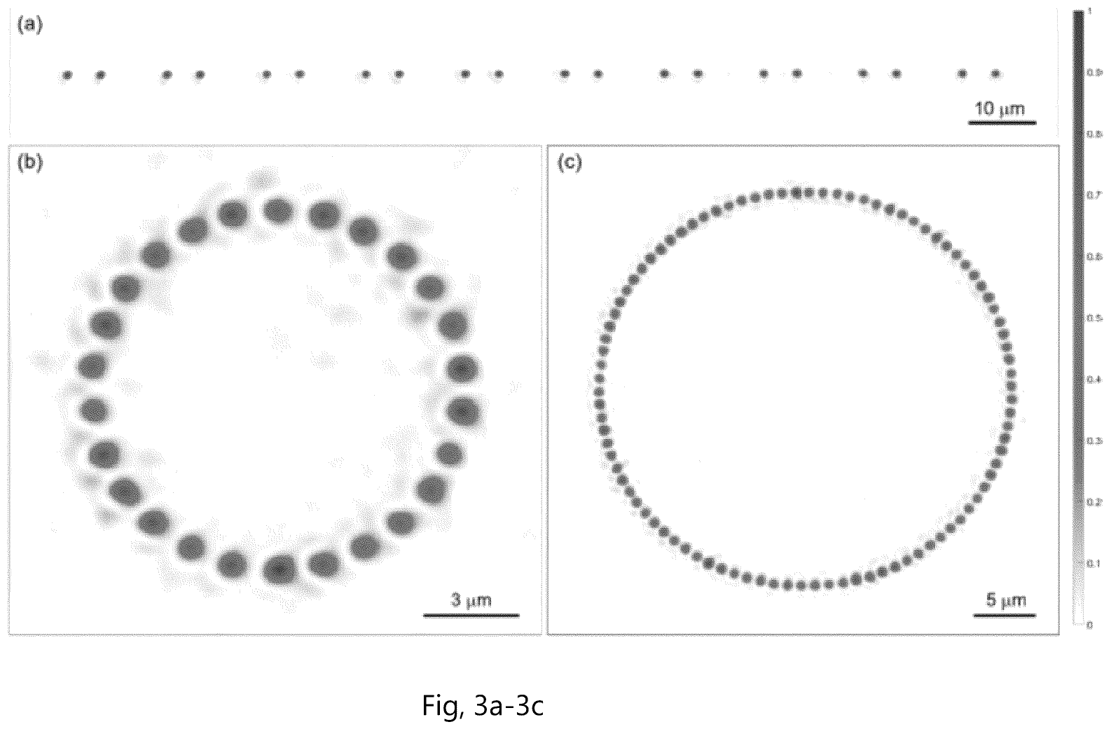

The measurement setup (illustrated in FIG. 2h) generates a number of trap arrays with different geometry configurations (shown in FIGS. 3-5) to demonstrate the performance of the metasurface holograms disclosed by the subject matter to generate arbitrary trapping geometry configurations. The demonstrated 1D arrays include a dimerized linear array with 5 μm spacing between two spots of the dimers and 10 μm spacing between adjacent dimers (FIG. 3a), and two ring arrays, one composed of 26 optical spots with 1.5 μm spacing between adjacent spots (FIG. 3b), and the other composed of 93 optical spots with 1.25 μm spacing between adjacent spots (FIG. 3c). Dimerized linear arrays can be utilized to achieve parallel control of multi-qubit gates using rubidium atoms and two-qubit gates using strontium atoms with high fidelity. For atoms arranged in a ring array, a spontaneous decay of excited atomic states can be exponentially suppressed, making them a promising platform for studying subradiant physics.

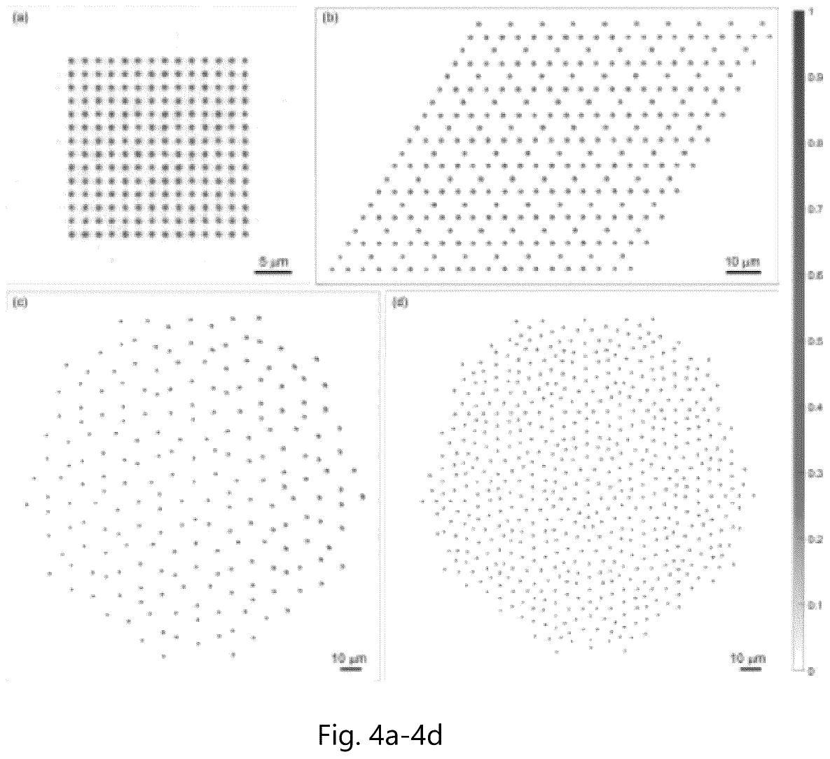

Demonstrated 2D arrays include a 14×14 square array with a lattice constant of 1.8 μm (FIG. 4a), a Kagome array composed of 300 optical spots with 5 μm spacing between the closest spots (FIG. 4b), and two Penrose-tiling type 2D quasi-crystal arrays, one composed of around 200 optical spots with the spacing between the closest spots of approximately 7.5 μm (FIG. 4c), and the other composed of double amount of optical spots (target spots and reservoir spots) with the spacing between the closest spots of approximately 4.5 μm (FIG. 4d). The reservoir spots can assist trapping cold atoms that can be subsequently moved to the target traps (as initial loading of atoms into the target traps is ˜50%). Kagome geometries with rubidium atoms can be used to realize quantum spin liquid phases, and interesting magnetic orderings have been demonstrated in Penrose-tiling geometries.

Demonstrated 3D arrays include a cubic array composed of 147 optical spots having three layers with each layer containing 7×7 optical spots with a lattice constant of 10 μm (FIG. 5d). In certain embodiments, using far-field scans at different distances from a metasurface hologram generates the trap array: three 7×7 square lattices are located at Z=0, 10, and 20 μm, respectively. The intensity profiles at different planes are normalized to their respective maxima; the maximum intensity at out-of-focus planes (Z=−5, 5, and 15 μm) is smaller than 5% of that at focal planes.

Alternative configurations and profiles for twisted bilayers consisting of either hexagonal or honeycomb 2D arrays are shown in FIG. 5a-5c, with 4 μm in-plane spacing between the closest spots and 10 μm inter-layer spacing. The twisting angle is 15° for the hexagonal bilayer and 20° for the honeycomb bilayer. The two layers are generated by the two polarization channels of a birefringent metasurface hologram. Some specific patterns are observed when the twisted bilayers are digitally overlapped on the same plot (FIG. 5b-5c). These cubic lattices can help enhance the connectivity between qubits in quantum computing devices based on neutral atoms. Twisted bilayer geometries with neutral atoms can provide a more controllable and flexible way to study twistronics compared with solid state systems. Based on the above discussion regarding geometry variety, the disclosed metasurface hologram can modulate and adjust the configurations of trap arrays.

Additionally, optical efficiencies are measured for all demonstrated trap arrays. Typical transmission efficiency, as defined by the ratio between power transmitted through a metasurface and power transmitted through a bare silicon dioxide substrate of the same size, can be between 60% and 70%, depending on the specific trap arrays configuration. The focusing efficiency, defined as the fraction of power focused onto the intended trap sites versus that of the incidence, is generally between 40% and 50%. Infinite-difference time-domain (FDTD) simulations, the transmission efficiency is around 80% and the focusing efficiency is around 65-70%.

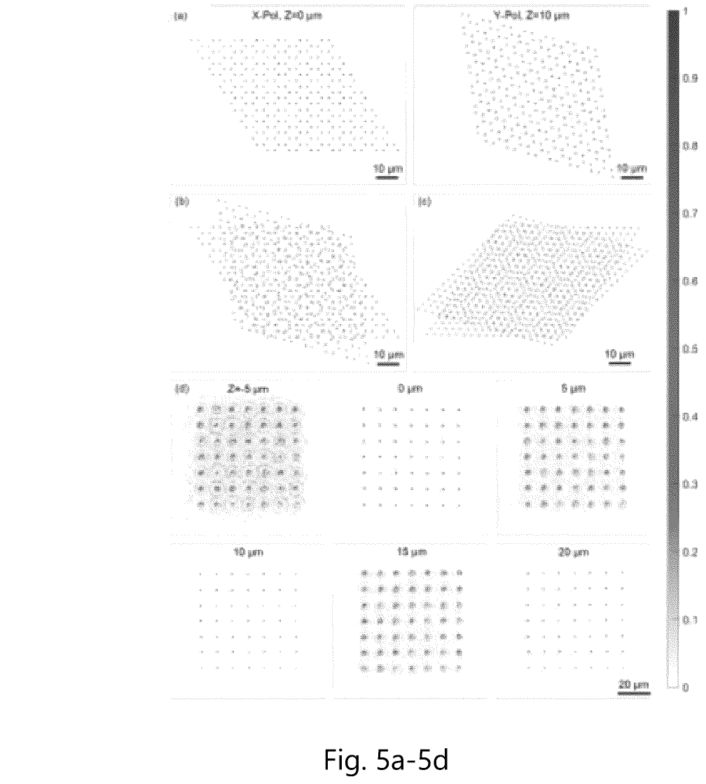

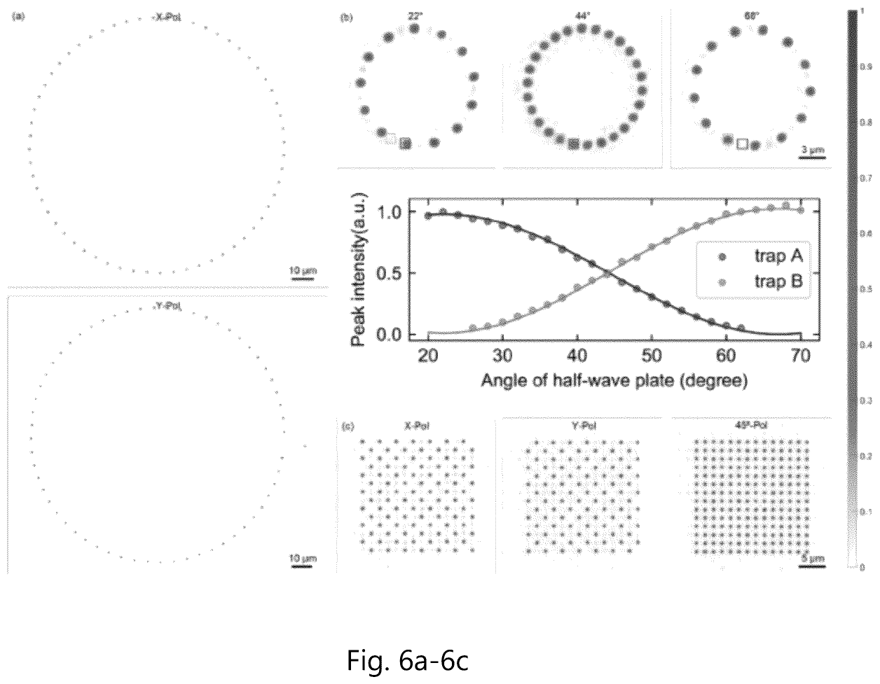

The discrepancy with simulations can originate from imperfect optical transparency of the TiO₂ films prepared, as well as errors in modeling and fabrication. In the embodiment shown in FIG. 6a, the measured intensity profiles of a polarization-switchable ring array are illustrated. Specifically, the ring can be switched between an intact state (top) and a defective state (bottom) and can enable the realization of a quantum memory. The switching has been demonstrated between an intact ring and a defective ring (with one optical spot displaced by a short distance out of the ring), when incident light is switched between two orthogonal linear polarizations. Atomic ring arrays are able to support deeply subradiant states, which can be accessed via local defects that facilitate the coupling with outside electromagnetic fields. The switching between perfect and defective rings can enable the realization of a quantum memory, where photons are stored and released via the mechanical motion of a single atom.

In the embodiment shown in FIG. 6b, a metasurface hologram generates two ring arrays with an offset in the azimuthal angular direction at horizontal and vertical incident polarization states, illustrated in FIG. 6b. Thus, when excited by the incident light with 45° linear polarization, the metasurface hologram generates a ring array with double the number of optical spots (i.e., the spacing between adjacent optical spots changes from 3 μm when excited by vertically or horizontally polarized light alone to 1.5 μm when excited by incident light with 45° linear polarization). Furthermore, continuously tuning the orientation of the incident linear polarization by gradually adjusting the angle of polarization of the incident light changes how the optical power is distributed between the two sub-rings. This tuning can effectively control the distribution of optical power and adds flexibility and adaptability to the holographic system, allowing for dynamic changes in the generated optical patterns.

FIG. 6b shows the peak intensity of two adjacent optical spots in the ring array as a function of the rotation angle of a half-wave plate used to control the orientation of the incident linear polarization. The data is fitted to a function of cos 2 (θ), where θ is the rotation angle of the half-wave plate. FIG. 6c shows another embodiment of a reconfigurable trap array where, by tuning the incident polarization states, the disclosed subject matter can switch the array between a checkerboard pattern and a square pattern with a lattice constant as small as 1.8 μm. A s illustrated, light at orthogonal polarization states generates spatially interleaved checkerboard patterns, which recombine into a square lattice at 45° incident polarization.

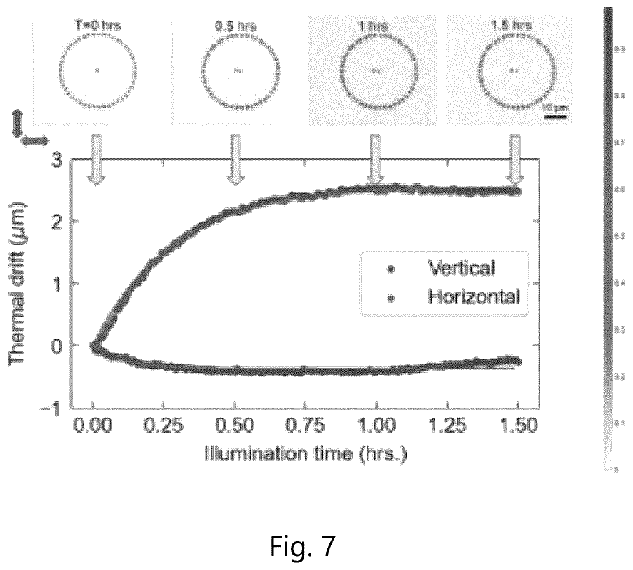

The thermal stability of trap arrays generated by metasurface holograms can be investigated by conducting in-situ measurements of the arrays with extended periods of high-power illumination. A metasurface hologram that produces a ring array with spacing between adjacent spots of around 2.5 μm can be illuminated with a collimated continuous wave laser beam at λ=520 nm with a beam diameter of ˜300 μm and a power of 2.75 W continuously for 1.5 h. A CCD camera can be used to monitor the generated trap array(s). The measured thermal stability of trap arrays with different time durations, e.g., at 0, 0.5, 1 and 1.5 h into the embodiment is presented in FIG. 7. There is no observed degradation of the array throughout the testing period, and a minor drift of the array along the vertical direction (<0.5 μm), and a drift along the horizontal direction of ˜2.5 μm at maximum. The time constants obtained from exponential fits are around 17 min for the vertical drift and around 6.6 min for the horizontal drift. This thermal stability can be desirable for cold atom applications such as atomic clocks which require an extended period of high-power illumination.

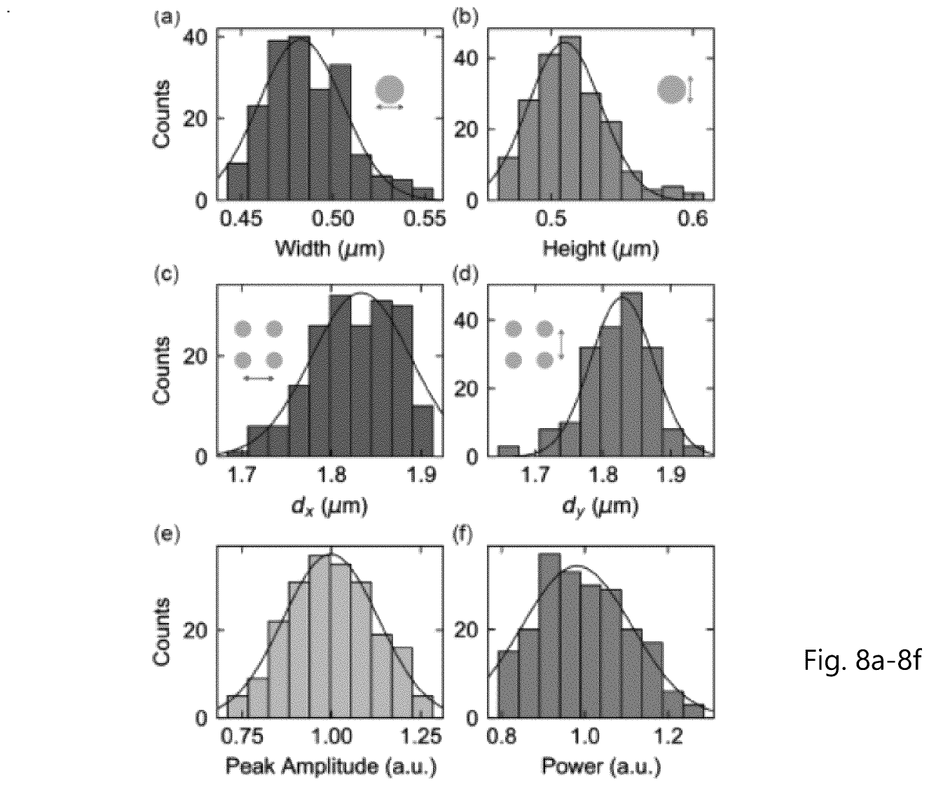

In certain embodiments, the positioning accuracy of the trap arrays is determined by extracting the locations of individual trap sites and conducting a statistical analysis of the distance between adjacent traps. Statistical histograms of measured geometrical parameters and intensities of optical traps generated by metasurfaces. FIGS. 8a-8b illustrate the distributions of the width and height of individual traps, respectively, of the 14×14 square lattice with a designed lattice constant of around 1.8 μm. FIGS. 8c-8d illustrate the distributions of the lattice constant of the 14×14 square lattice along the horizontal and vertical directions, respectively. FIGS. 8e-8f illustrate the distributions of the peak intensity and integrated power of the quasi-crystal trap, respectively. The integrated power of each trap site is evaluated by summing the pixel count over the trap. The measured average spacing between adjacent traps of the ring array with a designed spacing of 1.5 μm is 1.52 μm, while that of the square array with a designed lattice constant of 1.8 μm is 1.82 m along both the x- and y-axes (for example, shown in FIGS. 8c-8d standard deviations of the measured lattice constant are approximately 50 nm. The deviation of the measured spacing from the design and the variation are small compared to the wavelength and can be further reduced by using higher spatial resolution during the design of the metasurfaces, wherein the spatial discretization of both the metasurface and holographic planes is 70 nm in current designs.

In certain embodiments, the size and intensity uniformity of trap arrays are further characterized by extracting individual optical spots and using Gaussian fits to approximate their intensity profiles. In all traps presented in the disclosure, optical spots have full width at half maximum (FWHM) close to diffraction limited values. A statistical analysis is then performed to obtain the mean value and standard deviation of the sizes and peak intensity of the trap arrays. In particular, the results for the 2D Penrose-tiling type quasi-crystal lattice are shown in FIGS. 8e and 8f as an example. The statistics results on all 1D and 2D trap arrays generated by the metasurface hologram regarding intensity variations are listed in Table 1, where variation percentage is defined as the ratio between standard deviations and their corresponding mean values. In all trap arrays, a high geometrical uniformity is observed, with a variation of spot sizes between 3% and 5%.

TABLE 1

| | Width | Height | Height-width | Intensity |
|---|---|---|---|---|
| Geometries | variation | variation | difference | variation |
| 1 D-Dimerized | 4% | 3% | 0.90% | 12% |
| 1 D-1.5 μm Ring | 5% | 5% | 0.70% | 14% |
| 1 D-1.25 μm Ring | 4% | 5% | 3% | 16% |
| 2 D-Kagome | 4% | 5% | 8% | 16% |
| 2 D-1.8 μm | 5% | 5% | 2.40% | 14% |
| Square | | | | |
| 2 D-2 μm Square | 4.50% | 5.20% | 5% | 15% |
| 2 D-Penrose | 3.20% | 3.90% | 2.20% | 12% |

The highly uniform size of the trap spots shown in Table 1 reduces the difference in trapping frequency, which, for example, is favorable to achieve efficient Raman side-band cooling of a single atom trapped in an optical tweezer. The spots are close to isotropic in shape. In particular, a majority of the trap arrays display less than a 5% difference between spot sizes along the x- and y-axes. Such high isotropy allows trapped atoms to experience uniform confinement in the transverse directions. The intensity variation is between 12% and 16% for all the trap arrays (shown in Table 1), while in simulation they display an intensity variation below 2%. The variation in trap positions shown in Table 1 is sufficiently small to enable a high demand on the position accuracy in atomic arrays.

Features of trap arrays generated by metasurface holograms in the subject matter, are compared with traps created by certain AOD (Acousto-Optic Deflector) and SLM (Spatial Light Modulator) setups in Table 2. Certain advantages of metasurface holograms include their ability to produce arbitrary array geometries at arbitrary wavelengths with close spacing between traps, compact footprint, high optical efficiency, and excellent power handling capability. For the disclosed subject matter, there is no fundamental limit on the number of meta-units or nanopillars constituting a metasurface hologram, where typical metasurfaces already contain from 1 to 10 million meta-units and the number can be readily scaled up, allowing large-scale arrays with tens of thousands of trap sites. Another advantage of the disclosed metasurface hologram system is generate exceedingly large arrays while maintaining substantial optical intensity at each trap site requires high power-handling capability. In both regards, the scalability and high thermal stability of the disclosed metasurface holograms make them suitable for wide deployment of portable atomic systems such as atomic clocks. Additionally, it is noted that metasurface holograms disclosed in the subject matter are passive devices.

TABLE 2

| Characteristics | AOD | SLM | Metasurface hologram |
|---|---|---|---|
| Type | Active | Active | Passive |
| External power | Yes | Yes | No |
| Relay optics | Yes | Yes | No |
| Wavelength range | Specified by model | Specified by model | Specified by Arbitrary |
| Power handling | 10 W/cm² | 200 W/cm² | >1200 W/cm² |
| Device footprint | Tens of centimeters | Tens of centimeters | Millimeter |
| Spacing between | Dense (~1.2 μm | Dense (~1.5 μm | Dense (e.g., ~1.25 μm |
| trap | at λ = 515 nm) | at λ = 810 nm) | at λ = 520 nm) |
| Trap geometry | 2 D simple | Arbitrary pattern in | Arbitrary pattern in |
| | geometry | any dimension | any dimension |
| Power efficiency | ~50% | ~40% | ~60% |
| Peak variation | ~3% | ~3% | ~12% |

In summary, the disclosed subject matter generates metasurface holograms for trapping cold atoms with a variety of optical trap arrays geometries, and investages the merits of the trap arrays, including the homogeneity and positioning accuracy of the traps, and power handling capability of the metasurfaces. These above embodiments have shown that the generated holographic trap arrays possess high positioning accuracy, size uniformity, optical efficiency, and thermal stability. Importantly, the disclosed metasurface hologram can directly generate high-NA arrays with desired geometries without help from other optical elements, such as high-NA objectives commonly used in conjunction with other conventional atom trap devices. These features enable the disclosed metasurface holograms for use in applications that demand high-quality atomic arrays with dense spacing between hundreds and thousands of trap sites in a compact system. Additionally, the metasurface hologram platform disclosed can enable the study of exotic quantum optical phenomena, and can substantially reduce the complexity, volume, and cost of atomic-array-based quantum devices, including atomic clocks, and quantum simulation and computation systems.

Certain applications of atom trap arrays generated by the disclosed metasurface holographic optical trap system can be varied based on the individual geometries and spacing thereof for each application. Accordingly, the geometries include Kagome, triangular, honeycomb lattice, square lattice, dimerized traps, cubic lattice, and etc. Additionally, the interatomic spacing between the trapped atomic arrays can be ranged within microns dimension. Certain typical application examples include Quatum magnetism, quantum optics, atomic clocks, and quantum computing.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A metasurface holographic system, comprising:
a vacuum chamber configured to trap an atomic array;
an optics component, configured to modulate the trapped atomic array;
a laser generator, configured to generate one or more incident laser beams; and
a metasurface hologram, configured to receive the one or more incident laser beams and generate the trapped atomic array within the vacuum chamber.

2. The metasurface holographic system of claim 1, wherein the metasurface hologram is positioned outside the vacuum chamber.

3. The metasurface holographic system of claim 1, wherein the optics component is positioned between the metasurface hologram and the vacuum chamber.

4. The metasurface holographic system of claim 1, wherein the optics component includes a lens.

5. The metasurface holographic system of claim 1, wherein the metasurface hologram includes meta-units composed of polarization-independent and/or polarization-multiplexed units.

6. The metasurface holographic system of claim 5, wherein the meta-units include TiO₂ nanopillars.

7. The metasurface holographic system of claim 1, wherein the trapped atomic array includes at least a 3×3 square lattice array.

8. The metasurface holographic system of claim 1, wherein the trapped atomic array includes periodic and/or aperiodic geometry configurations with dimensions from 1D to 3D.

9. The metasurface holographic system of claim 8, wherein the trapped atomic array includes one or more geometries of quasi-crystals, Kagome lattices, and twisted bilayers.

10. The metasurface holographic system of claim 1, wherein the vacuum chamber is loaded with atomic gas.

11. The metasurface holographic system of claim 1, wherein the atomic array includes one or more atoms of alkali atoms, strontium, and ytterbium.

12. The metasurface holographic system of claim 1, wherein the trapped atomic array is configured to split into two parts, corresponding to two orthogonal polarization states.

13. The metasurface holographic system of claim 1, wherein a variation of spot sizes for the trapped atomic array ranges from 3% to 5%.

14. The metasurface holographic system of claim 1, wherein a variation of an intensity uniformity of the trapped atomic arrays ranges from 12% to 16%.

15. The metasurface holographic system of claim 1, wherein a spacing between the trapped atomic array is equal to or less than 1.25 μm.

16. The metasurface holographic system of claim 1, wherein a thermal stability of the trapped atomic array includes a first drift less than 0.5 μm along a vertical direction thereof, and a second drift equal to or less than 2.5 μm along a horizontal direction thereof.
